(19) United States
(12) Patent Application Publication
(10) Pub. No.: US 2012/0214338 A1
(43) Pub. Date: Aug. 23, 2012

(54) CONNECTOR HAVING CO-CYLINDRICAL CONTACT BETWEEN A SOCKET AND A CENTER CONDUCTOR

(75) Inventor: Adam Thomas Nugent, Canastota, NY (US)

(73) Assignee: JOHN MEZZALINGUA ASSOCIATES, INC., East Syracuse, NY (US)

(21) Appl. No.: 13/178,483

(22) Filed: Jul. 7, 2011

Related U.S. Application Data
(60) Provisional application No. 61/445,831, filed on Feb. 23, 2011.

(51) Int. Cl. H01R 9/05

(52) U.S. Cl. 439/578

(57) ABSTRACT

A connector comprising a main body having a first end and a second end, the main body configured to receive a prepared coaxial cable, a contact having a socket, the socket disposed within the main body and configured to receive a center conductor of the coaxial cable, and an insulator disposed within the main body, the insulator body having a first end and a second end, wherein a resultant contact between the socket and the center conductor is substantially co-cylindrical. Furthermore, an associated method is also provided.

### CROSS-REFERENCE TO RELATED APPLICATIONS

This application is a non-provisional application claiming the benefit of a priority to U.S. Provisional Application No. 61/445,831, filed Feb. 23, 2011, and entitled, “CONNECTOR HAVING CO-CYLINDRICAL CONTACT BETWEEN A SOCKET AND A CENTER CONDUCTOR.”

### FIELD OF TECHNOLOGY

The following relates to connectors used in coaxial cable communications, and more specifically to embodiments of a connector having an internal geometry to improve clamping of a center conductor.

### BACKGROUND

Coaxial cable is used to transmit radio frequency (RF) signals in various applications, such as connecting radio transmitters and receivers with their antennas, computer network connections, and distributing cable television signals. Coaxial cable typically includes an inner conductor, an insulating layer surrounding the inner conductor, an outer conductor surrounding the insulating layer, and a protective jacket surrounding the outer conductor. Each type of coaxial cable has a characteristic impedance which is the opposition to signal flow in the coaxial cable. The impedance of a coaxial cable depends on its dimensions and the materials used in its manufacture. For example, a coaxial cable can be tuned to a specific impedance by controlling the diameters of the inner and outer conductors and the dielectric constant of the insulating layer. All of the components of a coaxial system should have the same impedance in order to reduce internal reflections at connections between components. Such reflections increase signal loss and can result in the reflected signal reaching a receiver with a slight delay from the original.

Two sections of a coaxial cable in which it can be difficult to maintain a consistent impedance are the terminal sections on either end of the cable to which connectors are attached. For example, the attachment of some field-installable compression connectors requires the removal of a section of the insulating layer at the terminal end of the coaxial cable in order to insert a support structure of the compression connector between the inner conductor and the outer conductor. The support structure of the compression connector prevents the collapse of the outer conductor when the compression connector applies pressure to the outside of the outer conductor. Unfortunately, however, the dielectric constant of the support structure often differs from the dielectric constant of the insulating layer that the support structure replaces, which changes the impedance of the terminal ends of the coaxial cable. This change in the impedance at the terminal ends of the coaxial cable causes increased internal reflections, which results in increased signal loss.

Another difficulty with field-installable connectors, such as compression connectors or screw-together connectors, is maintaining acceptable levels of passive intermodulation (PIM). PIM in the terminal sections of a coaxial cable can result from nonlinear and insecure contact between surfaces of various components of the connector. A nonlinear contact between two or more of these surfaces can cause micro arcing or corona discharge between the surfaces, which can result in the creation of interfering RF signals. For example, some screw-together connectors are designed such that the contact force between the connector and the outer conductor is dependent on a continuing axial holding force of threaded components of the connector. Over time, the threaded components of the connector can inadvertently separate, thus resulting in nonlinear and insecure contact between the connector and the outer conductor.

Where the coaxial cable is employed on a cellular communications tower, for example, unacceptably high levels of PIM in terminal sections of the coaxial cable and resulting interfering RF signals can disrupt communication between sensitive receiver and transmitter equipment on the tower and lower-powered cellular devices. Disrupted communication can result in dropped calls or severely limited data rates, for example, which can result in dissatisfied customers and customer churn.

Current attempts to solve these difficulties with field-installable connectors generally consist of employing a pre-fabricated jumper cable having a standard length and having factory-installed soldered or welded connectors on either end. These soldered or welded connectors generally exhibit stable impedance matching and PIM performance over a wider range of dynamic conditions than current field-installable connectors. These pre-fabricated jumper cables are inconvenient, however, in many applications.

For example, each particular cellular communication tower in a cellular network generally requires various custom lengths of coaxial cable, necessitating the selection of various standard-length jumper cables that is each generally longer than needed, resulting in wasted cable. Also, employing a longer length of cable than is needed results in increased insertion loss in the cable. Further, excessive cable length takes up more space on the tower. Moreover, it can be inconvenient for an installation technician to have several lengths of jumper cable on hand instead of a single roll of cable that can be cut to the needed length. Also, factory testing of factory-installed soldered or welded connectors for compliance with impedance matching and PIM standards often reveals a relatively high percentage of non-compliant connectors. This percentage of non-compliant, and therefore unusable, connectors can be as high as about ten percent of the connectors in some manufacturing situations. For all these reasons, employing factory-installed soldered or welded connectors on standard-length jumper cables to solve the above-noted difficulties with field-installable connectors is not an ideal solution.

Accordingly, the contact between the center conductor and the receptive clamp is critical for desirable passive intermodulation (PIM) results. However, the timing associated with a connector moving into a closed position from an open position often times adversely affects the clamping of the incoming center conductor. The result of poor clamping leads to equally poor contact between the center conductor and the receptive clamp.

Thus, a need exists for an apparatus and method for a connector that provides efficient clamping of the center conductor.

### SUMMARY

A first general aspect relates to a connector comprising a main body having a first end and a second end, the main body configured to receive a prepared coaxial cable, and a compression member configured for axial movable engagement with the main body, wherein axial advancement of one of the main body and the compression member toward the other by axial compression facilitates substantially co-cylindrical contact between a socket and a center conductor of the coaxial cable.

A second general aspect relates to a connector comprising a main body having a first end and a second end, the main body configured to receive a prepared coaxial cable, an electrical contact disposed within the main body, the electrical contact having a socket configured to receive a center conductor of the coaxial cable, wherein the socket has a plurality of fingers, and an insulator body having a first end and a second end, the insulator body disposed within the main body, wherein the insulator body has a tapered opening proximate the second end, wherein the tapered opening of the insulator body gradually and evenly compresses the plurality of fingers onto the center conductor to achieve parallel line contact between the socket and the center conductor when the connector is in a closed position.

A third general aspect relates to a connector comprising a main body having a first end and a second end, the main body configured to receive a prepared coaxial cable, a compression member configured for axial movable engagement with the main body, and a means to compresses the plurality of fingers onto the center conductor to achieve parallel line contact between a socket and a center conductor when the connector is in a closed position.

A fourth general aspect relates to a device configured to be operably affixed to a coaxial cable comprising a compression connector, wherein the compression connector is configured to attached to the cable by the compression of at least one axially slidably movable component of the connector, wherein the compression connector achieves an intermodulation level below −155 dBc.

A fifth general aspect relates to a coaxial cable connector comprising a main body configured to receive a coaxial cable, a compression member configured for axial movable engagement with the main body, an insulator body having a first end and a second end, the insulator body disposed within the main body, wherein the insulator body has a tapered opening proximate the second end, and a cover disposed over at least a portion of the connector to seal the connector against environmental elements.

A sixth general aspect relates to a method of ensuring desirable contact between a center conductor of a coaxial cable and an electrical socket, comprising providing a main body having a first end and a second end, the main body configured to receive the coaxial cable, a compression member configured for axial movable engagement with the main body, disposing the electrical socket within the main body, the electrical socket configured to clamp the center conductor of the coaxial cable, wherein the socket has a plurality of fingers, disposing an insulator body within the main body, the insulator body having a first end and a second end, wherein the insulator body has a tapered opening proximate the second end, and compressing the plurality of fingers onto the center conductor to achieve parallel line contact between the socket and the center conductor when the connector is in a closed position.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a cross-sectional view of a first embodiment of a connector in an open position;

FIG. 2A depicts a cut-away perspective view of an embodiment of a coaxial cable;

FIG. 2B depicts a perspective view of an embodiment of the coaxial cable;

FIG. 3 depicts a perspective view of an embodiment of a main body of the connector;

FIG. 4 depicts a perspective view of an embodiment of a front body of the connector;

FIG. 5 depicts a cross-sectional view of the first embodiment of the connector in a closed position;

FIG. 6 depicts a cross-sectional view of a second embodiment of a connector in an open position;

FIG. 7 depicts a cross-sectional view of the second embodiment of the connector in a closed position;

FIG. 8 depicts a first view of a chart showing a performance of an embodiment of the first and second embodiments of the connector;

FIG. 9 depicts a perspective view of an embodiment of a coaxial cable connector having a cover in a first position; and

FIG. 10 depicts a perspective view of an embodiment of the coaxial cable connector having a cover in a second, sealing position.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

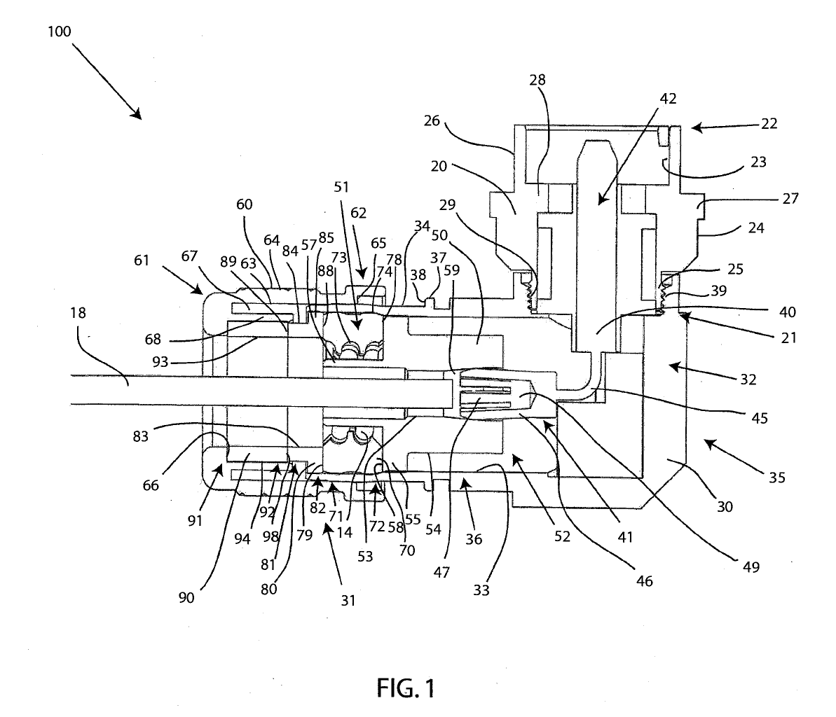

Referring to the drawings, FIG. 1 depicts an embodiment of a connector 100. Connector 100 may be a right angle connector, an angled connector, an elbow connector, an interface port, or any complimentary connector or port that may receive a center conductor 18 of a coaxial cable. Further embodiments of connector 100 may receive a center conductor 18 of a coaxial cable 10, wherein the coaxial cable 10 includes a corrugated, smoothwall, or otherwise exposed outer conductor 14. Connector 100 can be provided to a user in a preassembled configuration to ease handling and installation during use. Two connectors, such as connector 100 may be utilized to create a jumper that may be packaged and sold to a consumer. A jumper may be a coaxial cable 10 having a connector, such as connector 100, operably affixed at one end of the cable 10 where the cable 10 has been prepared, and another connector, such as connector 100, operably affixed at the other prepared end of the cable 10. Operably affixed to a prepared end of a cable 10 with respect to a jumper includes both an uncompressed/open position and a compressed/closed position of the connector while affixed to the cable. For example, embodiments of a jumper may include a first connector including components/features described in association with connector 100, and a second connector that may also include the components/features as described in association with connector 100, wherein the first connector is operably affixed to a first end of a coaxial cable 10, and the second connector is operably affixed to a second end of the coaxial cable 10. Embodiments of a jumper may include other components, such as one or more signal boosters, molded repeaters, and the like.

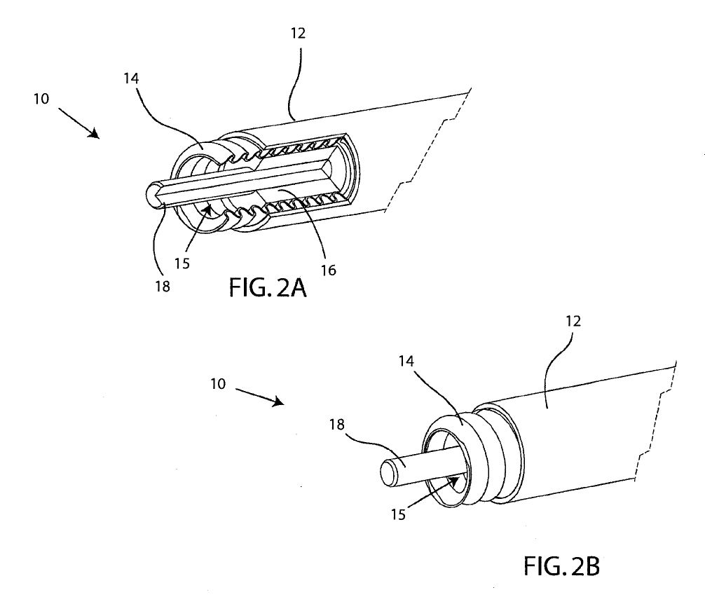

Referring to FIGS. 2A and 2B, embodiments of a coaxial cable 10 may be securely attached to a coaxial cable connector. The coaxial cable 10 may include a center conductor 18, such as a strand of conductive metallic material, surrounded by an interior dielectric 16; the interior dielectric 16 may possibly be surrounded by an outer conductor 14; the outer conductor 14 is surrounded by a protective outer jacket 12, wherein the protective outer jacket 12 has dielectric properties and serves as an insulator. The outer conductor 14 may extend a grounding path providing an electromagnetic shield about the center conductor 18 of the coaxial cable 10. The outer conductor 14 may be a semi-rigid outer conductor of the coaxial cable 10 formed of conductive metallic material, and may be corrugated or otherwise grooved. For instance, the outer conductor 14 may be smooth walled, annularly ribbed, spiral corrugated, or helical corrugated. The coaxial cable 10 may be prepared by removing a portion of the protective outer jacket 12 and coring out a portion of the dielectric 16 to expose the outer conductor 14 and create a cavity 15 or space between the outer conductor 14 and the center conductor 18. The protective outer jacket 12 can physically protect the various components of the coaxial cable 10 from damage that may result from exposure to dirt or moisture, and from corrosion. Moreover, the protective outer jacket 12 may serve in some measure to secure the various components of the coaxial cable 10 in a contained cable design that protects the cable 10 from damage related to movement during cable installation. The outer conductor 14 can be comprised of conductive materials suitable for carrying electromagnetic signals and/or providing an electrical ground connection or electrical path connection. Various embodiments of the outer conductor layer 14 may be employed to screen unwanted noise. The dielectric 16 may be comprised of materials suitable for electrical insulation. The protective outer jacket 12 may also be comprised of materials suitable for electrical insulation. It should be noted that the various materials of which all the various components of the coaxial cable 10 should have some degree of elasticity allowing the cable 10 to flex or bend in accordance with traditional broadband communications standards, installation methods and/or equipment. It should further be recognized that the radial thickness of the coaxial cable 10, protective outer jacket 12, outer conductor 14, interior dielectric 16, and/or center conductor 18 may vary based upon generally recognized parameters corresponding to broadband communication standards and/or equipment.

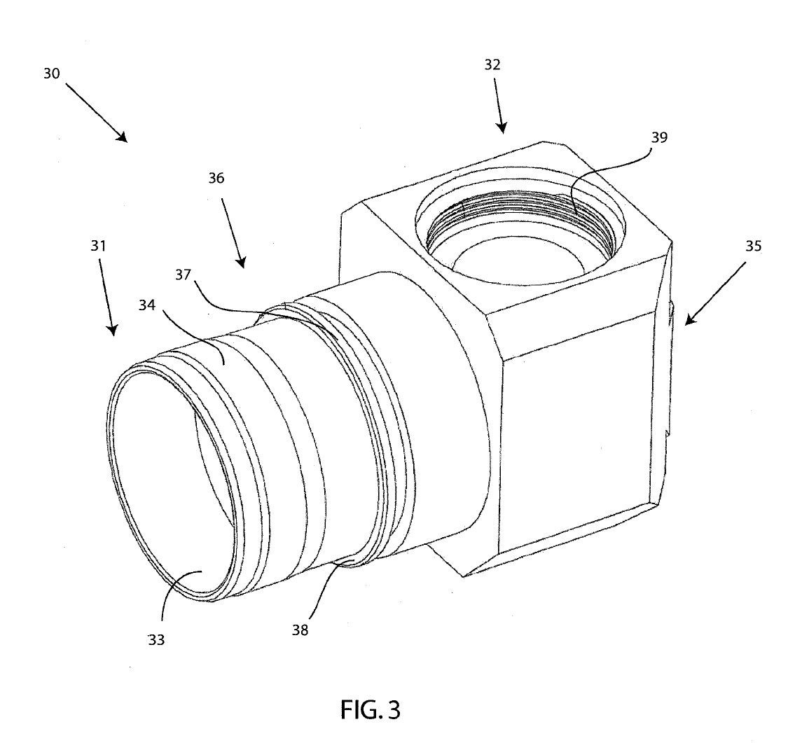

Referring now to FIGS. 1 and 3, embodiments of connector 100 may include a main body 30, a front body 20, a contact 40, an insulator body 50, an outer conductor engagement member 70, a flanged collar 80, a collar 90, and a compression member 60. Embodiments of connector 100 may include a main body 30 having a first end 31 and a second end 32, the main body 30 configured to receive a prepared coaxial cable 10, and a front body 20 operably attached to the main body 30, wherein the connector 100 has an internal geometry, the internal geometry results in substantially co-cylindrical contact between the socket 46 and the center conductor 18 when the connector 100 is in a closed position. Further embodiments of connector 100 may include a main body 30 having a first end 31 and a second end 32, the main body 30 configured to receive a prepared coaxial cable 10, a front body 20 operably attached to the main body 30, an electrical contact 40 disposed within the main body 30, the electrical contact 40 having a socket 46 configured to receive a center conductor 18 of the coaxial cable 10, wherein the socket 46 has a plurality of fingers 47, and an insulator body 50 having a first end 51 and a second end 52, the insulator body 50 disposed within the main body 30, wherein the insulator body 50 has a tapered opening 59 proximate the second end 52, wherein the tapered opening 59 of the insulator body 50 gradually and evenly compresses the plurality of fingers 47 onto the center conductor 18 to achieve parallel line contact between the socket 46 and the center conductor 18 when the connector 100 is in a closed position.

Embodiments of connector 100 may include a main body 30. Main body 30 may include a first end 31, a second end 32, an inner surface 33, and an outer surface 34. Main body 30 may further include a first portion 35 and a second portion 36. The first portion 35 of the main body 30 may be proximate the second end 32, and may have a generally axial opening in a longitudinal, or substantially longitudinal, direction. Embodiments of the first portion 35 of the main body 30 may also include a threaded portion 39 for threadably engaging, or securably retaining, a front body 20. The threaded portion 39 may be internal or interior female threads having a pitch and depth that correspond to external or exterior threads 29 of the front body 20. The second portion 36 of the main body 30 may extend from the first portion 35, and may be structurally integral with the first portion 35, or may be structurally independent (e.g. utilization of a coupling means) of the first portion 35 of the main body 30. Moreover, the second portion 36 may have a generally axial opening in a latitudinal, or substantially latitudinal, direction. The generally axial opening of the second portion 36 may extend from proximate the first end 31 and may be in communication with the generally axial opening of the first portion 35. The opening of the main body 30, or the second portion 36 of the main body 30, may include narrowing geometry to compress squeeze the outer conductor engagement member 70, causing deflection of the outer conductor engagement member 70 to clamp the outer conductor 14. For example, the opening within the main body 30 may taper gradually, causing the inner diameter to gradually decrease from the first end 31 to the second end 32 of the main body. Alternatively, the inner surface 33 of the main body may have a surface feature, such as a protrusion, ramped portion, bump, annular barb, and the like, that narrows the opening within the main body 30 to compress the outer conductor engagement member 70. The generally axial opening of the second portion 36 of the main body 30 may have an internal diameter large enough to allow an insulator body 50, an outer conductor engagement member 70, a flanged collar 80, a collar 90, and portions of a coaxial cable 10 to enter and remain disposed within the main body 30 while operably configured; however, the opening within the second portion 36 may decrease in diameter gradually or at one or more points to compress the outer conductor engagement member 70. In other words, the outer conductor engagement member 70 and other internal components may be radially compressed by the inner surface 33 of the main body 30 as the components are driven axially along within the main body 30. Embodiments of the main body 30 may include an annular protrusion 37 which may protrude or extend a distance from the outer surface 34 of the main body 30; the annular protrusion 37 may be disposed around the second portion 36 of the main body 30. The annular protrusion 37 may include a mating edge 38 (i.e. a face/side of the annular protrusion 37 which faces the first end 31 of the main body 30) that can mate with a mating edge, such as annular recessed portion 65 of a compression member 60 while in a closed position. In addition, the main body 30 may be formed of metals or polymers or other materials that would facilitate a rigidly formed body. Manufacture of the main body 30 may include casting, extruding, cutting, turning, tapping, drilling, injection molding, blow molding, or other fabrication methods that may provide efficient production of the component. Those in the art should appreciate that various embodiments of the main body 30 may also comprise various inner or outer surface features, such as annular grooves, detents, tapers, recesses, and the like, and may include one or more structural components having insulating properties located within the main body 30.

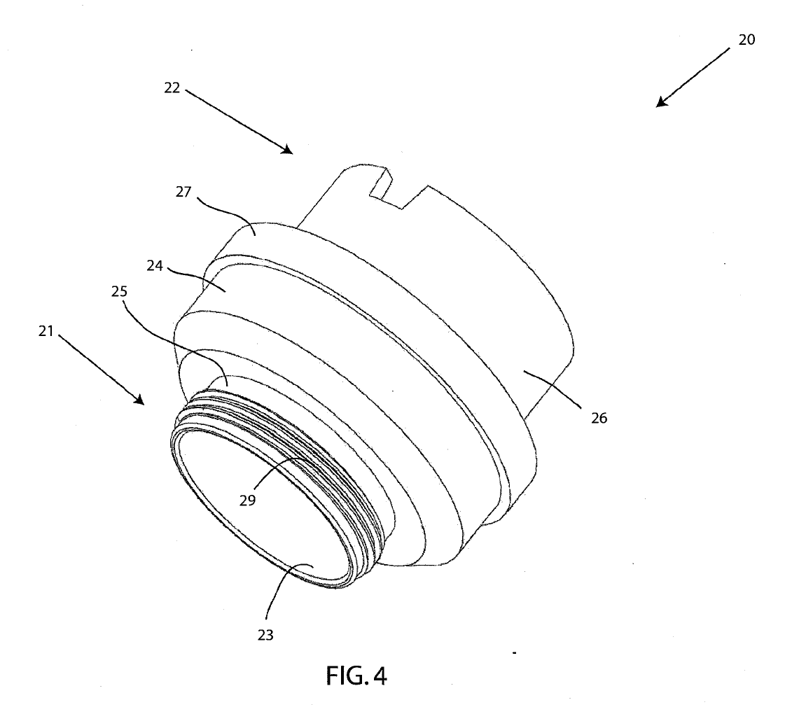

Referring still to FIG. 1, and with additional reference to FIG. 4, embodiments of connector 100 may include a front body 20. The front body 20 may include a first end 21, a second end 22, an inner surface 23, and an outer surface 24. Embodiments of the front body 20 may be a coupling member configured to mate with a corresponding port, or other connector; as such the front body 20 may include threads proximate the second end 22 to threadably mate with a port. Additionally, other embodiments of a front body 20 may operate with a separate coupler that is rotatably attached to the front body 20. The front body 20 may include a generally axial opening extending from the first end 21 to the second end 22. Proximate or otherwise near the first end 21 of the front body 20 may be an annular detent 25. The annular detent 25 may be sized and dimensioned to fit within the generally axial opening of the first portion 35 of the main body 30. Disposed on the outer surface of the annular detent 25 may be a threaded portion 29 for threadably engaging, or securably affixing to, the main body 30. In other words, the front body 20 may be coupled to the main body 30. The threaded portion 29 may be external or exterior threads having a pitch and depth that correspond to internal or interior female threads of the front body 20. Moreover, the front body 20 may include an annular recessed portion 26 proximate or otherwise near the second end 22. The annular recessed portion 26 may create a flange 27 extending annularly around the front body 20. Embodiments of the front body 20 may also include an internal protrusion 28 which may protrude or extend a distance from the inner surface 23 of the front body 20. In addition, the front body 20 may be formed of metals or polymers or other materials that would facilitate a rigidly formed body. Manufacture of the front body 20 may include casting, extruding, cutting, turning, tapping, drilling, injection molding, blow molding, or other fabrication methods that may provide efficient production of the component. Those in the art should appreciate that various embodiments of the front body 20 may also comprise various inner or outer surface features, such as annular grooves, detents, tapers, recesses, and the like, and may include one or more structural components having insulating properties located within the front body 20.

With continued reference to FIG. 1, embodiments of connector 100 may include a contact 40. Contact 40 may include a first end 41 and a second end 42. Further embodiments of connector 100 may include a contact 40 wherein a portion of the contact 40 may be disposed within the main body 30, and another portion may be disposed within the front body 20. Contact 40 may be a conductive element that may extend or carry an electrical current and/or signal from a first point to a second point. Contact 40 may be a terminal, a pin, a conductor, an electrical contact, a curved contact, a bended contact, an angled contact, and the like. Contact 40 may further include a connection portion 45 that may connect, or otherwise be disposed between, the first end 41 and the second end 42; the connection portion 45 may be structurally integral with the other portions of contact 40. Contact 40 may have various diameters, sizes, and may be arranged in any alignment throughout the connector 100, depending on the shape or orientation of the connection portion 45. For example, embodiments of connection portion 45 may be curved or otherwise non-linear in shape to achieve a curve-shaped contact 40. Further embodiments of contact 40 may include a bended or curved connection portion 45 to from a contact 40 that forms a right angle (i.e. 90), or a substantially right angle. Furthermore, contact 40 may be both female and male. The male electrical contacts may include spikes, or similar pointed protrusion, which may be configured to insert into a center conductor of a corresponding connector. In contrast, the female electrical contact may include sockets, or similar receptacle, which may be configured to receive an exposed, protruding center conductor, such as center conductor 18. Thus, electrical contact 40 may include a socket element at one end to receive, and a spike or similar element at the opposing end. The contact 40, including the connection portion 45 of the contact 40 should be formed of conductive materials.

Embodiments of contact 40 may include a socket 46 proximate or otherwise near the first end 41. The socket 46 may be a conductive center conductor clamp or basket that clamps, grips, collects, or mechanically compresses onto the center conductor 18. The socket 46 may further include an opening 49, wherein the opening 49 may be a bore, hole, channel, and the like, that may be tapered. The socket 46, in particular, the opening 49 of the socket 46 may accept, receive, and/or clamp an incoming center conductor 18 of the coaxial cable 10 as a coaxial cable 10 is further inserted into the main body 30 to achieve a closed position. The socket 46 may include a plurality of engagement fingers 47 that may permit deflection and reduce (or increase) the diameter or general size of the opening 49. In other words, the socket 46 of contact 40 may be slotted or otherwise resilient to permit deflection of the socket 46 as the coaxial cable 10 is further inserted into the main body 30 to achieve a closed position, or as the compression member 60 is axially displaced further onto main body 30. In an open position, or prior to full insertion of the coaxial cable 10, the plurality of engagement fingers 47 may be in a spread open configuration, or at rest, to efficiently engage, collect, capture, etc., the center conductor 18. Furthermore, the spread open configuration of the plurality of engagement fingers 47 may define a tapered opening 49 of the socket 46. Embodiments of a tapered opening 49 may taper, or become gradually larger in diameter towards the first end 41 of the socket 46. The tapered opening 49 embodiment may allow more contact (e.g. parallel line contact as opposed to point(s) contact) between the socket 46 and the center conductor 18 resulting in a more stable interface. For instance, the plurality of engagement fingers 47 may contact an internal surface 53 of a tapered opening 59 of the insulator body 50 that can radially compress the plurality of engagement fingers 47 onto the center conductor 18 as the coaxial cable 10 is further axially inserted into the main body 30, ensuring desirable passive intermodulation results. Alternatively, the plurality of engagement fingers 47 may be radially compressed cylindrically or substantially cylindrically around the center conductor 18 as compression member 60 is further axially inserted into the main body 30. Because of the internal geometry (e.g. cylindrical or tapered) of the insulator body 50 and the socket 46, the radial compression of the socket 46 onto the center conductor 18 may result in parallel line contact. In other words, the resultant contact between the socket 46 and the center conductor 18 may be co-cylindrical or substantially co-cylindrical.

Referring still to FIG. 1, embodiments of connector 100 may include an insulator body 50. The insulator body 50 may include a first end 51, a second end 52, an internal surface 53, and an outer surface 54. The insulator body 50 may be disposed within the main body 30. For example, the insulator body 50 may be disposed or otherwise located in the generally axial opening of the second portion 36 of the main body 30. The insulator body 50 may further include an opening 59 extending axially through the insulator body 50 from the first end 51 to the second end 52. The opening 59 may be a bore, hole, channel, tunnel, and the like, that may have a taper proximate the second end 52 of the insulator body 50. The insulator body 50, in particular, the opening 59 of the insulator body 50 may accept, receive, accommodate, etc., an incoming center conductor 18 of the coaxial cable 10 as a coaxial cable 10 is further inserted into the main body 30. The diameter or general size of the opening 59 should be large enough to accept the center conductor 18 of the coaxial cable 10, and may be approximately the same diameter or general size of the socket 46 of contact 40. For instance, the opening 59 of the insulator body 50 may be tapered or substantially cylindrical, and may be sized and dimensioned to provide only a slight clearance for the contact 40, such that when the connector 100 is compressed, the internal geometry of connector 100 may avoid point contact that may result from a larger amount of clearance between the contact 40 and the opening 59. Moreover, the internal geometry of the insulator body 50 and the socket 46 may avoid undesirable point contact, and establish line contact between the center conductor 18 and the socket 46. Proximate the second end 52 of the insulator body 50, the internal surface 53 of the opening 59 may be tapered such that the opening 59 becomes gradually larger towards the second end 52 of the insulator body 50. The internal surface 53 of the opening 59, tapered or otherwise, may initially engage the plurality of engagement fingers 47, and as the coaxial cable 10 is further inserted into the main body 30, the internal surface 53 of the opening 59 may compress the resilient engagement fingers 47 onto or around the center conductor 18 in a co-cylindrical or substantially co-cylindrical manner. Accordingly, the opposingly tapered openings 49, 59, act to gradually and evenly compress squeeze the socket 46 (i.e. engagement fingers 47) onto, or around, the center conductor 18 to achieve parallel line contact between the socket 46 and the center conductor 18 as the coaxial cable 10 is axially inserted into the main body 30. The openings 49, 59 having a tapered geometry embodiment may ensure that the socket 46 fully closes and fully captures the center conductor 18, and may provide delayed timing for fixed engagement of the socket 46 to the center conductor 18 as it enters the socket 46.

Those skilled in the art should appreciate that various geometric shapes of the internal components, such as the insulator body 50 and socket 46, may be used to achieve parallel or substantially parallel line contact between the socket 46 and the center conductor 18. Embodiments of connector 100 may include an insulator body 50 having a tapered opening 59 and a socket 46 with a tapered opening 49. Other embodiments of connector 100 may include an insulator body 50 with a cylindrical opening and a socket 46 with a tapered opening 49. Further embodiments of connector 100 may include an insulator body 50 with a cylindrical opening and a socket 46 with resilient fingers that may be spread out to freely accept center conductor 18 and deform once compressed by the compression member 60 to establish a parallel line contact or cylindrical contact around the center conductor 18. The internal geometry of the insulator body 50 and the socket 46 of the electrical contact 40 may be any configuration that will result in substantially co-cylindrical or co-cylindrical contact between an internal surface of the socket 46 and the outer surface of the center conductor 18. For instance, the cooperating surfaces of the socket 46 and the center conductor 18 may result in more surface contact (e.g. line contact, co-cylindrical contact, parallel physical contact) between them based on the internal geometry of connector 100 after or during compression of the connector 100 by a compression member 60 or insertion of an coaxial cable 10 into connector 100.

Moreover, embodiments of the insulator body 50 may include an annularly extending protrusion 55 which may protrude or extend a distance from the outer surface 54 of the insulator body 50. The diameter of the flange 55 may be substantially the same or slightly smaller than the diameter of the generally axial opening of the second portion 36 of the main body 30 to allow axial displacement of the insulator body 50 within the main body 30. The annular protrusion 55 may include a mating edge 58 (i.e. a face/side of the annular protrusion 55 which faces the first end 51 of the insulator body 50) that can mate with a mating edge 78 of an outer conductor engagement member 70, and a portion of the outer conductor 14 as the coaxial cable 10 is advanced through the main body 30. Further embodiments of the insulator body 50 may include an annular detent 57 proximate or otherwise near the first end 51 of the insulator body 50. The annular detent 57 may be sized and dimensioned to enter cavity 15 of the coaxial cable 10, wherein the cavity 15 is created when a portion of the dielectric 16 surrounding the center conductor 18 is removed or cored. The annular detent 57 may engage the dielectric 16, in particular a mating edge of the dielectric as the cable 10 is advanced into the main body 30. Thus, the annular detent 57 of the insulator body 50 may be disposed between the outer conductor 14 and the center conductor 18 in a closed position. Furthermore, the insulator body 50 should be made of non-conductive, insulator materials. Manufacture of the insulator body 50 may include casting, extruding, cutting, turning, drilling, compression molding, injection molding, spraying, or other fabrication methods that may provide efficient production of the component.

Referring again to FIG. 1, embodiments of connector 100 may include an outer conductor engagement member 70. The outer conductor engagement member 70 may include a first end 71, a second end 72, an inner surface 73, and an outer surface 74. The outer conductor engagement member 70 may be disposed within the main body 30 proximate or otherwise near the insulator body 50. For instance, the outer conductor engagement member 70 may be disposed between the flanged collar 80 and the insulator body 50. Moreover, the outer conductor engagement member 70 may be disposed around the outer conductor 14, wherein the inner surface 73 may engage, threadably or otherwise, the outer conductor 14. For example, the inner surface 73 may include threads or grooves that may correspond to the threads or grooves of the outer conductor 14. Embodiments of the outer conductor engagement member 70 may include an inner surface 73 with threads or grooves that correspond with a helical corrugated outer conductor. Other embodiments of the outer conductor engagement member 70 may include an inner surface 73 with threads or grooves that correspond with a spiral corrugated outer conductor. Further embodiments of the outer conductor engagement member 70 may include an inner surface 73 that suitably engages a smooth wall outer conductor. Furthermore, embodiments of the outer conductor engagement member 70 may include a first mating edge 78 proximate or otherwise near the second end 72 and a second mating edge 79 proximate or otherwise near the first end 71. The first mating edge 78 may engage the mating edge 58 of the insulator body 50 as the coaxial cable 10 is further inserted into the axial opening of the main body 30. Similarly, the second mating edge 79 may engage a first mating edge 88 of the flanged collar 80 as the coaxial cable is advanced through the main body 30 proximate the first end 31. The outer conductor engagement member 70 may be radially compressed by an internal geometry of the main body 30, wherein the compression of the outer conductor engagement member 70 onto the outer conductor 14 effectively clamps the outer conductor 14, preventing or substantially hindering movement of the cable when the connector 100 is in a closed position. Furthermore, the outer conductor engagement member 70 may be made of conductive materials. Manufacture of the outer conductor engagement member 70 may include casting, extruding, cutting, turning, drilling, compression molding, injection molding, spraying, or other fabrication methods that may provide efficient production of the component.

Embodiments of connector 100 may further include a flanged collar 80. The flanged collar 80 may include a first end 81, a second end 82, an inner surface 83, and an outer surface 84. The flanged collar 80 may be a generally annular tubular member. The flanged collar 80 may be disposed within the main body 30 proximate or otherwise near the outer conductor engagement member 70. For instance, flanged collar 80 may be disposed between the collar 90 and the outer conductor engagement member 70. Moreover, the flanged collar 80 may be disposed around the dielectric 16 of the coaxial cable 10 when the cable 10 enters the connector 100. Further embodiments of the flanged collar 80 can include a flange 85 proximate or otherwise near the second end 82. The flange 85 may protrude or extend a distance from the outer surface 84. The flange 85 may create a space or cavity between the outer surface 84 of the flanged collar 80 and the inner surface 33 of the main body 30 to allow a portion of the compression member 60 to slide between the flanged collar 80 and the main body 30 as the connector 100 is moved into the closed position. The flanged collar 80 may also include a mating edge 88 proximate or otherwise near the second end 82 that may engage the second mating edge 79 of the outer conductor engagement member 70 and a mating edge 89 proximate or otherwise near the first end 81 that may engage mating edge 98 of the collar 80 as the coaxial cable 10 is further inserted into the axial opening of the main body 30. Additionally, the flanged collar 80 may be made of non-conductive, insulator materials. Alternatively, the flanged collar 80 may be made of conductive materials. Manufacture of the flanged collar 80 may include casting, extruding, cutting, turning, drilling, compression molding, injection molding, spraying, or other fabrication methods that may provide efficient production of the component.

With reference still to FIG. 1, embodiments of connector 100 may include a collar 90. The collar 90 may include a first end 91, a second end 92, an inner surface 93, and an outer surface 94. The collar 90 may be a generally annular tubular member. The collar 90 may be a solid sleeve collar and may be disposed within the main body 30 proximate or otherwise near the flanged collar 80. For instance, collar 90 may be disposed around the cable jacket 12 of the coaxial cable 10 when the cable 10 enters the connector 100, which may form a seal around the cable 10. For instance, as the compression member 60 is axially compressed, the collar 90 may deform and sealingly engage the cable jacket 12 to prevent the ingress of environmental elements, such as rainwater. Further embodiments of the collar 90 may also include a mating edge 98 proximate or otherwise near the second end 92 that may engage the mating edge 89 of the flanged collar 80 as the coaxial cable 10 is further inserted into the axial opening of the main body 30. Additionally, the collar 90 should be made of non-conductive, insulator materials, and can be made of elastomeric materials. Manufacture of the collar 90 may include casting, extruding, cutting, turning, drilling, compression molding, injection molding, spraying, or other fabrication methods that may provide efficient production of the component.

Embodiments of connector 100 may also include a compression member 60. The compression member 60 may have a first end 61, second end 62, inner surface 63, and outer surface 64. The compression member 60 may be a generally annular member having a generally axial opening therethrough. The compression member 60 may be disposed over or around a portion of the main body 30. For instance, the compression member 60 may surround the second portion 36 of the main body 30. Proximate or otherwise near the second end 62, the compression member 60 may include an internal annular recessed portion 65. The internal annular recessed portion 65 may engage the mating edge 38 of the annular protrusion 37 of the main body 30 as the connector 100 moves from an open to a closed position. For instance, the compression member 60 may axially slide towards the second end 32 of the main body 30 until the internal recessed portion 65 physically or mechanically engages the annular protrusion 37 of the main body 30. Moreover, the compression member 60 may include an annular lip 66 proximate or otherwise near the first end 61. The annular lip 66 may be configured to engage the collar 90 as the connector 100 is moved to a closed position. The compression member 60 may further include a cavity 67 proximate or otherwise near the first end 61. The cavity 67 may be a space, opening, void, and the like, which may be located between the inner surface 63 of the compression member 60 and an inner portion 68. The inner portion 68 may be an annular member which can be parallel to the outer structural surface of the compression member 60. Embodiments of the inner portion 68 may be structurally integral with the compression member 60 and may extend a distance into the generally axially opening of the compression member 60, while maintaining a radial distance from the inner surface 63 of the compression member 60. The inner portion 68 may surround or substantially surround the cable jacket 12 of the coaxial cable 10 when the cable 10 is present in the connector 100. The cavity 67 may accommodate, receive, accept, etc., a portion of the main body 30 as the compression member 60 is axially displaced onto the main body 30. Furthermore, it should be recognized, by those skilled in the requisite art, that the compression member 60 may be formed of rigid materials such as metals, hard plastics, polymers, composites and the like, and/or combinations thereof. Furthermore, the compression member 60 may be manufactured via casting, extruding, cutting, turning, drilling, knurling, injection molding, spraying, blow molding, component overmolding, combinations thereof, or other fabrication methods that may provide efficient production of the component. Those in the art should appreciate that the compression member 60 may movably engage the main 30 body in a manner in which the compression member moves within a portion of the main body 30.

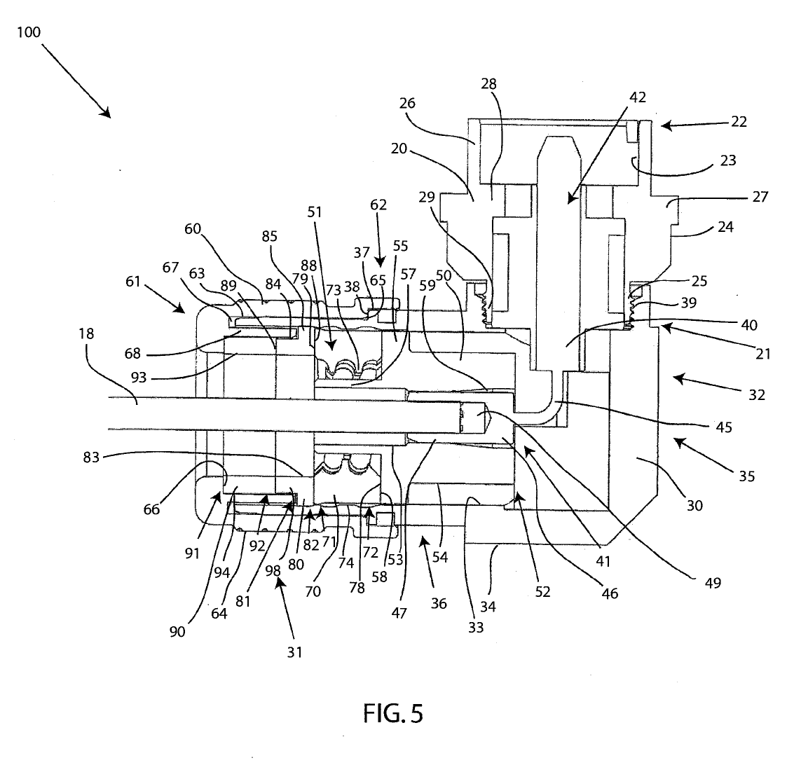

Referring now to FIG. 1 and FIG. 5, the manner in which connector 100 may move from an open position to a closed position is now described. FIG. 1 depicts an embodiment of the connector 100 in an open position. The open position may refer to a position or arrangement wherein the center conductor 18 of the coaxial cable 10 is not clamped or captured by the socket 46 of contact 40, or only partially/initially clamped or captured by the socket 46. The cable 10 may enter the generally axially opening of the compression member 60, and the outer conductor 14 engages the outer conductor engagement member 70. The outer conductor 14 may mate with the outer conductor engagement member 70. For example, the outer conductor 14 may be threaded onto the outer conductor engagement member 70, or may simply be pushed 9 axially) further into the main body 30. In some embodiments, the connector 100 may be rotated or twisted to provide the necessary rotational movement of the outer conductor engagement member 70 to mechanically engage, or threadably engage, the outer conductor 14. Alternatively, in other embodiments, the coaxial cable 10 may be rotated or twisted to provide the necessary rotational movement of the outer conductor engagement member 70 to mechanically engage, or threadably engage, the outer conductor 14. The engagement between the outer conductor 14 and the outer conductor engagement member 70 may establish a mechanical connection between the connector 100 and the coaxial cable 10. Those skilled in the art should appreciate that mechanical communication or interference may be established without threadably engaging an outer conductor 14, such as friction fit between the cable 10 and the connector 100.

FIG. 5 depicts an embodiment of a closed position of the connector 100. The closed position may refer to a position or arrangement of the connector 100 wherein the center conductor 18 is fully clamped or accepted by the socket 46 of contact 40. The closed position may be achieved by axially compressing the compression member 60 onto the main body 30 (other embodiments may be configured such that the compression member 60 is compressed into the main body 30). For instance, the second end 62 of the compression member 60 may extend an axial distance so that, when the compression member 60 is compressed into a sealing position on the coaxial cable 100, the compression member 60 may touch or reside proximate or otherwise near the first portion 35 of the main body 30. The axial movement of the compression member 60 can axially displace the cable 10 and other components disposed within the main body 30, such as 50, 70, 80, and 90, because of the mechanical engagement between the lip 66 of the compression member 60 and the collar 90, the mechanical engagement of the inner portion 68 and the mating edge 89 of the flanged collar 80 (when the collar 90 is deformed), or a combination thereof. Thus, the collar 90 and/or the inner portion 68 may then mechanically engage the flanged collar 80, which can mechanically engage the outer conductor engagement member 70. The outer conductor engagement member 70 may engage the insulator body 50 to axially displace the insulator body 50 further onto the socket 46, but may also axially displace the cable 10 due to mechanical interference with the outer conductor 14. As described supra, the opposingly tapered openings 49, 59, of the socket 46 and insulator body 50, respectively, may act to gradually and evenly compress squeeze the socket 46 onto, or around, the center conductor 18 to achieve parallel line contact between the socket 46 and the center conductor 18 as the coaxial cable 10 is axially inserted into the connector 100. Parallel line contact between the center conductor 18 and the socket, in addition to the tight clamping of the center conductor 18, can achieve desirable PIM results because non-linear and insecure contact between them is avoided.

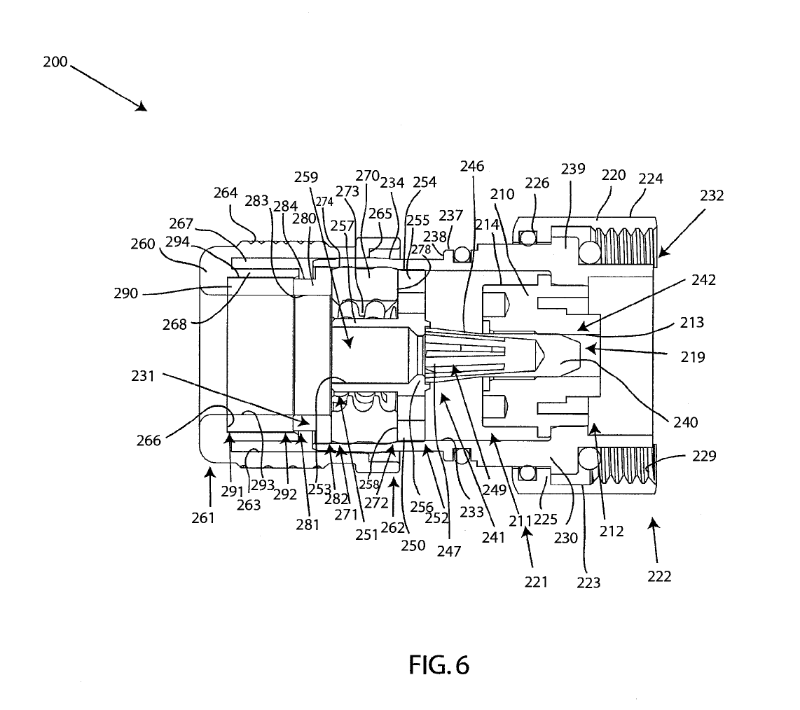

Referring to the drawings, FIG. 6 depicts an embodiment of a connector 200 in an open position. Connector 200 may share include similar components and function of connector 100; however, connector 200 may be a straight coaxial cable connector or any complimentary connector or port that may receive a center conductor 18 of a coaxial cable 10. Further embodiments of connector 200 may receive a center conductor 18 of a coaxial cable 10, wherein the coaxial cable 10 includes a corrugated, smoothwall, or otherwise exposed outer conductor 14. Connector 200 can be provided to a user in a preassembled configuration to ease handling and installation during use.

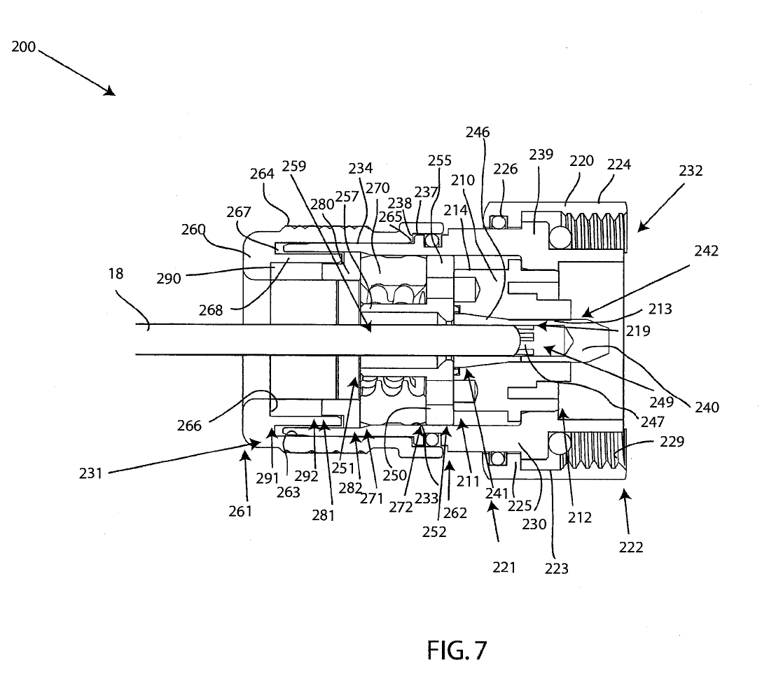

Embodiments of connector 200 may include a main body 230, a coupler 220, a contact 240, an insulator body 250, a contact component 210, an outer conductor engagement member 270, a flanged collar 280, a collar 290, and a compression member 260. Embodiments of the outer conductor engagement member 270, a flanged collar 280, a collar 290, and a compression member 260 described in association with connector 200 may share the same or substantially the same structure and function as described above in association with connector 100. For example, the outer conductor engagement member 270 may include a first end 271, a second end 272, an inner surface 273, and an outer surface 274. The outer conductor engagement member 270 may engage the outer conductor 14 of cable 10. The flanged collar 280 may include a first end 281, a second end 282, an inner surface 283, and may be an annular tubular member having a flange proximate the second end 282, disposed between the outer conductor engagement member 270 and the collar 290 within the main body 230. Additionally, the collar 290 may have a first end 291, a second end 292, an inner surface 293, an outer surface 284, and may be an annular tubular member disposed within the main body 230 proximate the flanged collar 290. The compression member 260 may include a first end 261, a second end 262, an inner surface 623, and an outer surface 264, and may be axially displaced to move connector 200 from an open position (shown in FIG. 6) to a closed position (shown in FIG. 7). The compression member 260 may further include a cavity 267 proximate or otherwise near the first end 261. The cavity 267 may be a space, opening, void, and the like, which may be located between the inner surface 263 of the compression member 260 and an inner portion 268. The inner portion 268 may be an annular member which can be parallel to the outer structural surface of the compression member 260.

Embodiments of connector 200 may include a main body 230. Main body 230 may include a first end 231, a second end 232, an inner surface 233, and an outer surface 234. The main body 230 may include a lip 239 for limiting axial movement of a coupler 220 (e.g. a threaded nut) disposed around the main body 230 proximate or otherwise near the second end 232. Moreover, the main body 230 may have a generally axial opening in a latitudinal, or substantially latitudinal, direction, and may have a similar internal geometry as described in association with main body 30 of connector 100. The generally axial opening of the main body 230 may extend from proximate the first end 231 and through the second end 232 of the main body 230. The generally axial opening of the second portion 236 of the main body 230 may have an internal diameter large enough to allow an insulator body 250, an outer conductor engagement member 270, a collar 290, and portions of a coaxial cable 10 to enter and remain disposed within the main body 230 while operably configured. While disposed within the main body 230, the outer conductor engagement member 270, and other internal components, may be radially compressed by the inner surface 233 of the main body 230. Embodiments of the main body 230 may include an annular protrusion 237 which may protrude or extend a distance from the outer surface 234 of the main body 230. The annular protrusion 237 may include a mating edge 238 (i.e. a face/side of the annular protrusion 237 which faces the first end 231 of the main body 230) that can mate with a mating edge, such as annular recessed portion 265 of a compression member 260 while in a closed, or compressed, position. In addition, the main body 230 may be formed of metals or polymers or other materials that would facilitate a rigidly formed body. Manufacture of the main body 230 may include casting, extruding, cutting, turning, tapping, drilling, injection molding, blow molding, or other fabrication methods that may provide efficient production of the component. Those in the art should appreciate that various embodiments of the main body 230 may also comprise various inner or outer surface features, such as annular grooves, detents, tapers, recesses, and the like, and may include one or more structural components having insulating properties located within the main body 230.

Referring still to FIG. 7, embodiments of connector 200 may include a coupler 220. The coupler 220 may include a first end 221, a second end 222, an inner surface 223, and an outer surface 224. The coupler 220 may disposed proximate or otherwise near the second end 232 of the main body 230, and may achieve rotational movement about the main body 230. Embodiments of the coupler 220 may include a generally axial opening extending from the first end 221 to the second end 222. Proximate or otherwise near the first end 221 of the coupler 220 may be an annular lip 225. The annular lip 225 may engage the lip 239 of the main body 230, which may hinder axial movement of the coupler 220. Disposed on the internal surface 223 proximate or otherwise near the second end 222 of the coupler 220 may be a threaded portion 229 for threadably engaging, securably affixing to, or mating with a corresponding cable interface port or a corresponding coaxial cable connector. Moreover, the coupler 220 may include an annular recessed portion 226 proximate or otherwise near the first end 221 to accommodate an O-ring or other resilient member. The coupler 220 may also be a coupling member having internal threads, configured to connect, accommodate, receive, or couple with an additional coaxial cable connector. In addition, the coupler 220 may be formed of metals or polymers or other materials that would facilitate a rigidly formed body. Manufacture of the coupler 220 may include casting, extruding, cutting, turning, tapping, drilling, injection molding, blow molding, or other fabrication methods that may provide efficient production of the component. Those in the art should appreciate that various embodiments of the coupler 220 may also comprise various inner or outer surface features, such as annular grooves, detents, tapers, recesses, and the like, and may include one or more structural components having insulating properties located within the coupler 220.

With continued reference to FIG. 6, embodiments of connector 200 may include a contact 240. Contact 240 may include a first end 241 and a second end 242 and may be disposed within the main body 230. Contact 240 may be a conductive element that may extend or carry an electrical current and/or signal from a first point to a second point. Contact 240 may be a terminal, a pin, a conductor, an electrical contact, and the like. Furthermore, contact 240 may be both female and male, and should be formed of conductive materials.

Embodiments of contact 240 may include a socket 246 proximate or otherwise near the first end 241. The socket 246 may be a conductive center conductor clamp or basket that clamps, grips, collects, or mechanically compresses onto the center conductor 18. The socket 246 may further include an opening 249, wherein the opening 249 may be a bore, hole, channel, and the like, that may be tapered. The socket 246, in particular, the opening 249 of the socket 246 may accept, receive, and/or clamp an incoming center conductor 18 of the coaxial cable 10 as a coaxial cable 10 is further inserted into the main body 230 to achieve a closed position. The socket 246 may include a plurality of engagement fingers 247 that may permit deflection and reduce (or increase) the diameter or general size of the opening 249. In other words, the socket 246 of contact 240 may be slotted or otherwise resilient to permit deflection of the socket 246 as the coaxial cable 10 is further inserted into the main body 230 to achieve a closed position, or as the compression member 260 is axially displaced further onto main body 230. In an open position, or prior to full insertion of the coaxial cable 10, the plurality of engagement fingers 247 may be in a spread open configuration, or at rest, to efficiently engage, collect, capture, etc., the center conductor 18. Furthermore, the spread open configuration of the plurality of engagement fingers 247 may define a tapered opening 249 of the socket 246. Embodiments of a tapered opening 249 may taper, or become gradually larger in diameter towards the first end 241 of the socket 246. The tapered opening 249 may allow more contact (e.g. parallel line contact as opposed to point(s) contact) between the socket 246 and the center conductor 18 resulting in a more stable interface. For instance, the plurality of engagement fingers 247 may contact an internal surface 253 of a tapered opening 259 of the insulator body 250 that can radially compress the plurality of engagement fingers 247 onto the center conductor 18 as the coaxial cable 10 is further axially inserted into the main body 230, ensuring desirable passive intermodulation results. Alternatively, the plurality of engagement fingers 247 may be radially compressed cylindrically or substantially cylindrically around the center conductor 18 as compression member 260 is further axially inserted onto the main body 230. Because of the internal geometry (cylindrical or tapered) of the insulator body 250 and the socket 246, the radial compression of the socket 246 onto the center conductor 18 may result in parallel line contact. In other words, the resultant contact between the socket 246 and the center conductor 18 may be co-cylindrical or substantially co-cylindrical.

Referring still to FIG. 6, embodiments of connector 200 may include an insulator body 250. The insulator body 250 may include a first end 251, a second end 252, an internal surface 253, and an outer surface 254. The insulator body 250 may be disposed within the main body 230. For example, the insulator body 250 may be disposed or otherwise located in the generally axial opening of the main body 230. The insulator body 250 may further include an opening 259 extending axially through the insulator body 250 from the first end 251 through the second end 252. The opening 259 may be a bore, hole, channel, tunnel, and the like. The insulator body 250, in particular, the opening 259 of the insulator body 50 may accept, receive, accommodate, etc., an incoming center conductor 18 of the coaxial cable 10 as a coaxial cable 10 is further inserted into the main body 230. The diameter or general size of the opening 259 should be large enough to accept the center conductor 18 of the coaxial cable 10, but may be slightly smaller proximate the point of engagement with the socket 246 of contact 240 to mechanically engage the fingers 247 of socket 246. Proximate the second end 252, the insulator body 250 may include an internal lip 256. The internal lip 256 may provide a mating surface for socket 246, and may extend or radially protrude into opening 259 of the insulator body 250. The insulator body 250 may initially engage the plurality of engagement fingers 247, and as the coaxial cable 10 is further inserted into the main body 230, the insulator body 250 may drive or axially displace the contact 240 towards the second end 232 of the main body 230 due to the mechanical interference between the internal lip 256 and the plurality of engagement fingers 247 of the socket 246. As the coaxial cable 10 is further inserted into the main body 230, the internal surface 213 of a contact component 210 disposed within the main body 230 may compress the resilient engagement fingers 247 onto or around the center conductor 18 in a co-cylindrical or substantially co-cylindrical manner.

Moreover, embodiments of the insulator body 250 may include an annularly extending protrusion 255 which may protrude or extend a distance from the outer surface 254 of the insulator body 250. The diameter of the flange 255 may be substantially the same or slightly smaller than the diameter of the generally axial opening of the of the main body 230 to allow axial displacement of the insulator body 250 within the main body 230. The annular protrusion 255 may include a mating edge 258 (i.e. a face/side of the annular protrusion 255 which faces the first end 251 of the insulator body 250) that can mate with a mating edge 278 of an outer conductor engagement member 270, and a portion of the outer conductor 14 as the coaxial cable 10 is advanced through the main body 230. Further embodiments of the insulator body 250 may include an annular detent 257 proximate or otherwise near the first end 251 of the insulator body 250. The annular detent 257 may be sized and dimensioned to enter cavity 15 of the coaxial cable 10, wherein the cavity 15 is created when a portion of the dielectric 16 surrounding the center conductor 18 is removed or cored. The annular detent 257 may engage the dielectric 16, in particular a mating edge of the dielectric as the cable 10 is advanced into the main body 230. Thus, the annular detent 257 of the insulator body 250 may be disposed between the outer conductor 14 and the center conductor 18 in a closed position. Furthermore, the insulator body 250 should be made of non-conductive, insulator materials. Manufacture of the insulator body 250 may include casting, extruding, cutting, turning, drilling, compression molding, injection molding, spraying, or other fabrication methods that may provide efficient production of the component.

Embodiments of connector 200 may also include a contact component 210. The contact component 210 may include a first end 211, a second end 212, an inner surface 213, and an outer surface 214. The contact component 210 may be disposed within the main body 230, wherein the contact component 210 surrounds or substantially surrounds at least a portion of contact 240. Moreover, the contact component 210 may include an axially extending opening 219 which may extend from the first end 211 through the second end 212. The opening 219 may be a bore, hole, channel, tunnel, and the like. The contact component 210, in particular, the opening 219 of the contact component 210 may accept, receive, accommodate, etc., the axially displaced electrical contact 240 and center conductor 18 of the coaxial cable 10 as a coaxial cable 10 is further inserted into the main body 230. The opening 219 of the contact component 210 may be tapered or substantially cylindrical, and may be sized and dimensioned to provide only a slight clearance for the incoming contact 240, such that when compressed, the internal geometry of connector 200 may avoid point contact resulting from a larger amount of clearance between the contact 240 and the opening 219. Accordingly, as the socket 246 having opening 249 enters opening 219 of the contact component 210, the socket 247 (i.e. engagement fingers 247) may be gradually and evenly compress squeezed onto, or around, the center conductor 18 to achieve parallel line contact between the socket 246 and the center conductor 18 as the coaxial cable 10 is axially inserted into the main body 230. The internal geometry of openings 219, 249 may ensure that the socket 246 fully closes and fully captures the center conductor 18, and may provide delayed timing as the center conductor 18 enters the socket 246.

Those skilled in the art should appreciate that various geometric shapes of the internal components, such as the contact component 210 and socket 246, may be used to achieve parallel or substantially parallel line contact between the socket 246 and the center conductor 18. Embodiments of connector 200 may include a contact component 210 having a tapered opening 219 and a socket 246 with a tapered opening 249. Other embodiments of connector 200 may include a contact component 210 with a cylindrical opening and a socket 246 with a tapered opening 249. Further embodiments of connector 200 may include contact component 210 with a cylindrical opening and a socket 246 with resilient fingers that may be spread out to freely accept center conductor 18 and deform once compressed by the compression member 260 to establish a parallel line contact or cylindrical contact around the center conductor 18. The internal geometry of the contact component 210 and the socket 246 of the electrical contact 240 may be any configuration that will result in substantially co-cylindrical or co-cylindrical contact between an internal surface of the socket 246 and the outer surface of the center conductor 18. For instance, the cooperating surfaces of the socket 246 and the center conductor 18 may result in more surface contact (e.g. line contact, co-cylindrical contact, parallel physical contact) between them based on the internal geometry of connector 200 after or during compression of the connector 200 by a compression member 260 or insertion of an coaxial cable 10 into connector 200.

Referring now to FIG. 6 and FIG. 7, the manner in which connector 200 may move from an open position to a closed position is now described. FIG. 6 depicts an embodiment of the connector 200 in an open position. The open position may refer to a position or arrangement wherein the center conductor 18 of the coaxial cable 10 is not clamped or captured by the socket 246 of contact 240, or only partially/initially clamped or captured by the socket 246. The cable 10 may enter the generally axially opening of the compression member 260, and the outer conductor 14 engages the outer conductor engagement member 270. The outer conductor 14 may mate with the outer conductor engagement member 270. For example, the outer conductor 14 may be threaded onto the outer conductor engagement member 270, or may simply be pushed (axially) further into the main body 30. In some embodiments, the connector 200 may be rotated or twisted to provide the necessary rotational movement of the outer conductor engagement member 270 to mechanically engage, or threadably engage, the outer conductor 14. Alternatively, in other embodiments, the coaxial cable 10 may be rotated or twisted to provide the necessary rotational movement of the outer conductor engagement member 270 to mechanically engage, or threadably engage, the outer conductor 14. The engagement between the outer conductor 14 and the outer conductor engagement member 270 may establish a mechanical connection between the connector 200 and the coaxial cable 10. Those skilled in the art should appreciate that mechanical communication or interference may be established without threadably engaging an outer conductor 14, such as friction fit between the cable 10 and the connector 100.

FIG. 7 depicts an embodiment of a closed position of the connector 200. The closed position may refer to a position or arrangement of the connector 200 wherein the center conductor 18 is fully clamped or accepted by the socket 246 of contact 240. The closed position may be achieved by axially compressing the compression member 260 onto the main body 230. For instance, the second end 262 of the compression member 260 may extend an axial distance so that, when the compression member 260 is compressed into a sealing position on the coaxial cable 10, the compression member 260 may touch or reside proximate or otherwise near the coupler 220. The axial movement of the compression member 260 can axially displace the cable 10 and other components disposed within the main body 230, such as 250, 270, 280, and 290, because of the mechanical engagement between the lip 266 of the compression member 260 and the collar 290. The collar 290 may then mechanically engage the flanged collar 280, which may mechanically engage the outer conductor engagement member 270. The outer conductor engagement member 270 may engage the insulator body 250 to axially displace the insulator body 250 into engagement with the socket 246, but may also axially displace the cable 10 due to mechanical interference with the outer conductor 14. As described supra, the axial movement of the insulator body causes axial displacement of the contact 240 into the opening 219 of the contact component 210. The geometry of the openings 249, 219 of the socket 246 and contact component 210, respectively, may act to gradually and evenly compress squeeze the socket 246 onto, or around, the center conductor 18 to achieve parallel contact between the socket 246 and the center conductor 18 as the coaxial cable 10 is axially inserted into the connector 200.

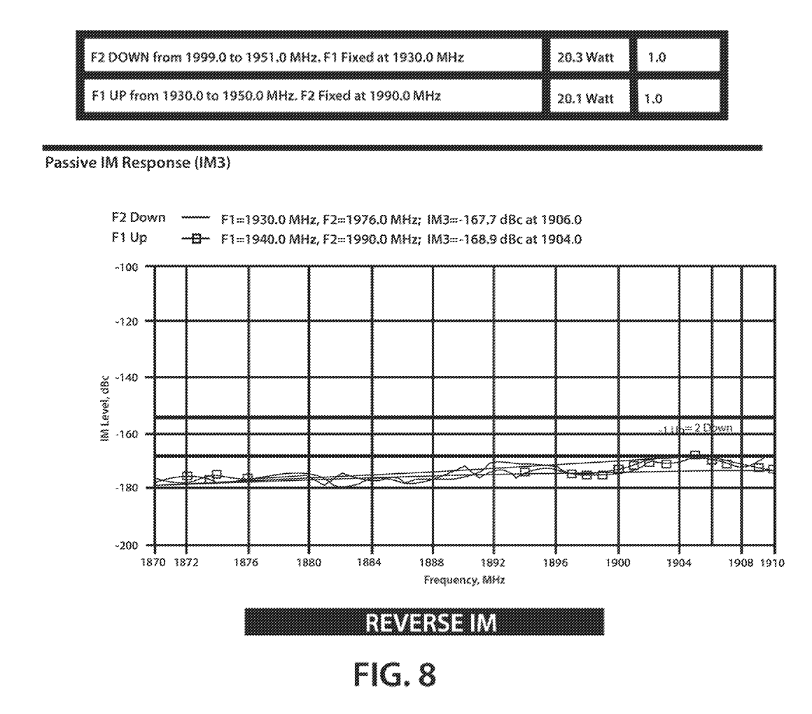

FIG. 8 discloses a chart showing the results of PIM testing performed on the coaxial cable 10 that was terminated using the example compression connector 100, 200. The particular test used is known to those having skill in the requisite art as the International Electrotechnical Commission (IEC) Rotational Test. The PIM testing that produced the results in the chart was also performed under dynamic conditions with impulses and vibrations applied to the example compression connector 100, 200 during the testing. As disclosed in the chart, the PIM levels of the example compression connector, 100, 200 were measured on signals F1 UP and F2 DOWN to vary significantly less across frequencies 1870-1910 MHz. Further, the PIM levels of the example compression connector 100, 200 remained well below the minimum acceptable industry standard of −155 dBc. For example, F1 UP achieved an intermodulation (IM) level of −168.9 dBc at 1904 Mhz, while F2 DOWN achieved an intermodulation (IM) level of −167.7 dBc at 1906 Mhz. These superior PIM levels of the example compression connector 100, 200 are due at least in part to the clamping of the coaxial cable 10, in particular, the co-cylindrical, line contact between the center conductor 18 and the socket 46 when the connector in the closed position, as described supra.

Compression connectors having PIM levels above this minimum acceptable standard of −155 dBc result in interfering RF signals that disrupt communication between sensitive receiver and transmitter equipment on the tower and lower-powered cellular devices in 4G systems. Advantageously, the relatively low PIM levels achieved using the example compression connector 100, 200 surpass the minimum acceptable level of −155 dBc, thus reducing these interfering RF signals. Accordingly, the example field-installable compression connector 100, 200 enables coaxial cable technicians to perform terminations of coaxial cable in the field that have sufficiently low levels of PIM to enable reliable 4G wireless communication. Advantageously, the example field-installable compression connector 100, 200 exhibits impedance matching and PIM characteristics that match or exceed the corresponding characteristics of less convenient factory-installed soldered or welded connectors on pre-fabricated jumper cables. Accordingly, embodiments of connector 100, 200 may be a compression connector, wherein the compression connector achieves an intermodulation level below −155 dBc over a frequency of 1870 MHz to 1910 MHz.

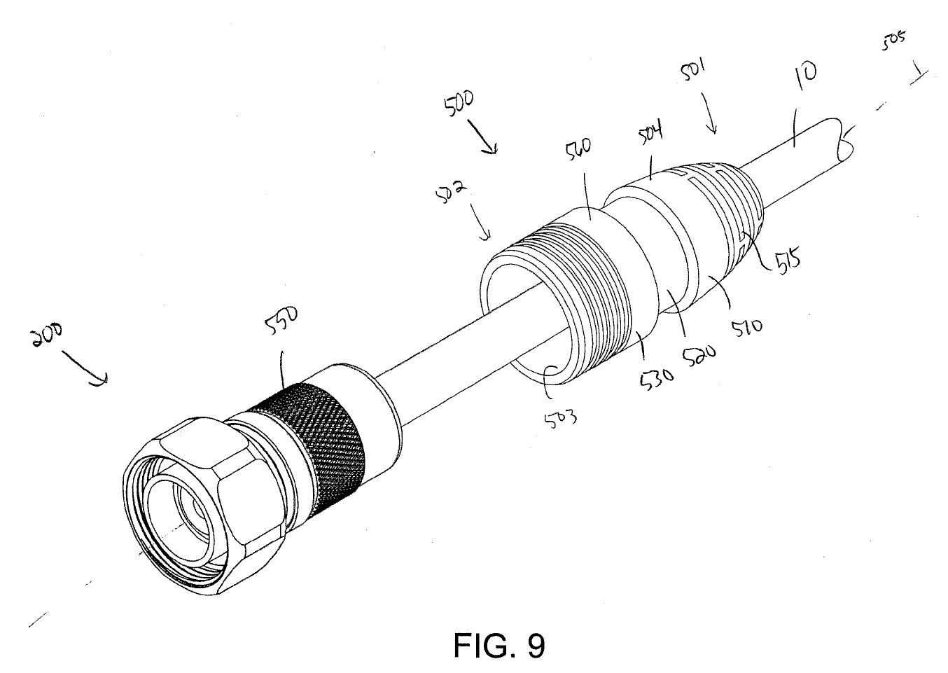

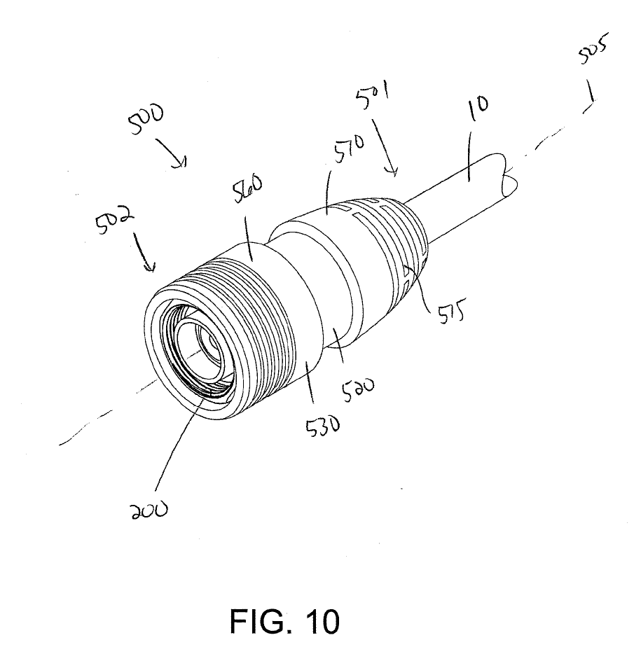

With continued reference to the drawings, FIGS. 9 and 10 depict an embodiment of connector 200 having a cover 500. FIG. 10 depicts an embodiment of connector 200 having a cover 500 in a first position. FIG. 11 depicts an embodiment of connector 200 having a cover 500 in a second, sealing position. Cover 500 may be a seal, a sealing member, a sealing boot, a sealing boot assembly, and the like, that may be quickly installed and/or removed over a connector, such as connector 200, and may terminate at a bulkhead of a port or at a sliced connection with another coaxial cable connector of various sizes/shapes. Cover 500 can protect the cable connectors or other components from the environment, such as moisture and other environmental elements, and can maintain its sealing properties regardless of temperature fluctuations. Embodiments of cover 500 may be a cover for a connector 200 adapted to terminate a cable 10, wherein the cover 500 comprises an elongated body 560 comprising a cable end 501 and a coupler end 502, an interior surface 503 and an exterior surface 504, wherein the elongated body 560 extends along a longitudinal axis 505. The interior surface 503 can include a first region 510 adapted to cover at least a portion of the cable 10 and can extend from the cable end 501 to a first shoulder, wherein the first region is of a minimum, first cross-sectional diameter. The interior surface 503 may further include a second region 520 which is adapted to cover at least the connector body portion 550 and which may extend from the first shoulder to a second shoulder. The second region 520 may have a minimum, second cross-sectional diameter that is greater than the minimum, first cross-sectional diameter. The interior surface 503 may further include a third region 530 which is adapted to cover at least a portion of the connector 200 and which extends from the second shoulder to the coupler end 502. The third region 530 may have a minimum, third cross-sectional diameter that is greater than the minimum, second cross-sectional diameter. Further embodiments of the cover 500 may include a plurality of circumferential grooves 515 to provide strain relief as the cover moves from the first position to the second position. The circumferential grooves 515 can extend less than completely around the circumference of the first region 510 of cover 500. Furthermore, embodiments of the cover 500 may comprise an elastomeric material that maintains its sealing abilities during temperature fluctuations. In one embodiment, the cover 500 is made of silicone rubber.

Referring now to FIGS. 1-10, a method of method of ensuring desirable contact between a center conductor 18 of a coaxial cable 10 and an electrical socket 46, may include the steps of providing a main body 30 having a first end 31 and a second end 32, the main body 30 configured to receive the coaxial cable 10, and a compression member configured for axial movable engagement with the main body main body 30, disposing the electrical socket 46 within the main body 30, the electrical socket 46 configured to clamp the center conductor 18 of the coaxial cable 10, wherein the socket 46 has a plurality of fingers 47, disposing an insulator body 50 within the main body 30, the insulator body 50 having a first end 51 and a second end 52, wherein the insulator body 50 has a tapered opening 59 proximate the second end 52, and compressing the plurality of fingers 47 onto the center conductor 18 to achieve parallel line contact between the socket 46 and the center conductor 18 when the connector is in a closed position.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A connector comprising:
a main body having a first end and a second end, the main body configured to receive a prepared coaxial cable; and
a compression member configured for axial movable engagement with the main body;
wherein axial advancement of one of the main body and the compression member toward the other by axial compression facilitates substantially co-cylindrical contact between a socket and a center conductor of the coaxial cable.

2. The connector of claim 1, wherein the center conductor is fully clamped within the main body when the connector is in the closed position.

3. The connector of claim 1, further comprising:
an electrical contact having a socket, the socket disposed within the main body and configured to receive a center conductor of the coaxial cable; and
an insulator body disposed within the main body, the insulator body having a first end and a second end.

4. The connector of claim 1, wherein the internal geometry of the connector includes opposingly tapered surfaces of the insulator body and the socket of the electrical contact.

5. The connector of claim 1, wherein the internal geometry of the connector includes the insulator body having a tapered opening proximate the second end.

6. The connector of claim 1, wherein the internal geometry of the connector includes the socket having a tapered opening.

7. The connector of claim 1, wherein the internal geometry of the connector includes the socket having a cylindrical opening and the insulator body has a tapered opening.

8. The connector of claim 1, wherein the internal geometry of the connector includes the socket having a tapered opening and the insulator body having a cylindrical opening.

9. The connector of claim 1, wherein the internal geometry of the connector includes the socket and the insulator body having cylindrical openings.

10. The connector of claim 1, wherein a collar is disposed proximate the first end of the main body to form a seal around the coaxial cable.

11. The connector of claim 1, wherein the compression member is configured to be axially compressed onto the main body.

12. The connector of claim 1, wherein the connector is a right angle connector.

13. The connector of claim 1, wherein the connector is a straight connector.

14. A connector comprising:
a main body having a first end and a second end, the main body configured to receive a prepared coaxial cable;
an electrical contact disposed within the main body, the electrical contact having a socket configured to receive a center conductor of the coaxial cable, wherein the socket has a plurality of fingers; and
an insulator body having a first end and a second end, the insulator body disposed within the main body, wherein the insulator body has a tapered opening proximate the second end;
wherein the tapered opening of the insulator body gradually and evenly compresses the plurality of fingers onto the center conductor to achieve parallel line contact between the socket and the center conductor when the connector is in a closed position.

15. The connector of claim 14, wherein the plurality of fingers are separated by axial openings to permit radially inward deflection of the fingers when the connector moves from an open position to the closed position.

16. The connector of claim 14, wherein the plurality of fingers are in a spread open configuration when the connector is in the open position.

17. The connector of claim 14, wherein a collar is disposed proximate the first end of the main body to form a seal around the coaxial cable.

18. The connector of claim 14, further comprising:
a compression member configured to be axially compressed onto the main body.

19. The connector of claim 14, wherein the connector is a right angle connector.

20. The connector of claim 14, wherein the connector is a straight connector.

21. A connector comprising:
a main body having a first end and a second end, the main body configured to receive a prepared coaxial cable;
a compression member configured for axial movable engagement with the main body; and
a means to compresses the plurality of fingers onto the center conductor to achieve parallel line contact between a socket and a center conductor when the connector is in a closed position.

22. The connector of claim 21, wherein the means includes an internal geometry of the connector.

23. The connector of claim 21, wherein the connector is a right angle connector.

24. The connector of claim 21, wherein the connector is a straight connector.

25. A device configured to be operably affixed to a coaxial cable comprising:
a compression connector, wherein the compression connector is configured to attached to the cable by the compression of at least one axially slidably movable component of the connector;
wherein the compression connector achieves an intermodulation level below −155 dBc.

26. The device of claim 25, wherein the compression connector includes:
a main body configured to receive a prepared coaxial cable;
a compression member configured for axial movable engagement with the main body;
an electrical contact disposed within the main body, the electrical contact having a socket configured to receive a center conductor of the coaxial cable, wherein the socket has a plurality of fingers; and
an insulator body having a first end and a second end, the insulator body disposed within the main body, wherein the insulator body has a tapered opening proximate the second end

27. The device of claim 25, wherein the compression connector achieves an intermodulation level below −165 at approximately 1905 MHz.

28. The device of claim 25, wherein the intermodulation level of the compression connector is determined according to the IEC Rotational Test Standard.

29. A coaxial cable connector comprising:
a main body configured to receive a coaxial cable;
a compression member configured for axial movable engagement with the main body;
an insulator body having a first end and a second end, the insulator body disposed within the main body, wherein the insulator body has a tapered opening proximate the second end; and
a cover disposed over at least a portion of the connector to seal the connector against environmental elements.

30. The coaxial cable connector of claim 29, wherein the cover is an elastomeric material configured to be quickly removed and installed.

31. The coaxial cable connector of claim 29, wherein the compression member is configured to be axially compressed onto the main body.

32. The connector of claim 29, further comprising:
an electrical contact having a socket, the socket disposed within the main body and configured to receive a center conductor of the coaxial cable; and
an insulator body disposed within the main body, the insulator body having a first end and a second end.

33. A method of ensuring desirable contact between a center conductor of a coaxial cable and an electrical socket, comprising:
providing a main body having a first end and a second end, the main body configured to receive the coaxial cable, and a compression member configured for axial movable engagement with the main body;
disposing the electrical socket within the main body, the electrical socket configured to clamp the center conductor of the coaxial cable, wherein the socket has a plurality of fingers;
disposing an insulator body within the main body, the insulator body having a first end and a second end, wherein the insulator body has a tapered opening proximate the second end; and
compressing the plurality of fingers onto the center conductor to achieve parallel line contact between the socket and the center conductor when the connector is in a closed position.

34. The method of claim 33, wherein the plurality of fingers are separated by axial openings to permit radially inward deflection of the fingers when the connector moves from an open position to the closed position.

35. The method of claim 33, wherein the plurality of fingers are in a spread open configuration when the connector is in the open position.

36. The method of claim 33, further comprising:
forming a seal around the coaxial cable proximate the first end of the main body, wherein the seal is formed by a collar disposed proximate the first end of the main body.

37. The method of claim 33, further comprising:
providing a compression member surrounding the first end of the main body, the compression member configured to be axially compressed onto the main body.

38. The method of claim 33, wherein the connector is a right angle connector.

39. The method of claim 33, wherein the connector is a straight connector.
